(19) United States
(12) Patent Application Publication
(10) Pub. No.: US 2023/0288044 A1
(43) Pub. Date: Sep. 14, 2023

(54) LED LIGHTING FIXTURE HAVING MULTIPLE LED CLUSTERS WITH RELATIVE ANGULAR DISPLACEMENT (ROTATION)

(71) Applicant: LMPG Inc., Longueuil (CA)

(72) Inventors: David Michael Grassi, Montreal (CA); Isabelle Rivard, Longueuil (CA)

(73) Assignee: LMPG Inc., Longueuil (CA)

(21) Appl. No.: 18/118,329

(22) Filed: Mar. 7, 2023

Related U.S. Application Data
(60) Provisional application No. 63/317,412, filed on Mar. 7, 2022.

(51) Int. Cl. F21V 5/00

(52) U.S. Cl. CPC F21V 5/007; F21Y 2115/10

(57) ABSTRACT

A light-emitting diode (LED) lighting fixture includes a substrate and a plurality of LED clusters disposed on the substrate in a plane in which two orthogonal axes defining a two-dimension coordinate system is disposed. At least two of the LED clusters have orientations which are relatively angularly displaced within the two-dimensional coordinate system.

### CROSS-REFERENCE TO RELATED APPLICATIONS

The present application is related to and claims the benefit of U.S. Provisional Application No. 63/317,412, filed on Mar. 7, 2022, the entire contents of which are incorporated herein by reference.

### BACKGROUND

### 1. Technical Field

The present disclosure is related to lighting systems and, in particular, to color changing lighting systems.

### 2. Discussion of Related Art

In interior and exterior lighting systems, it is desirable to use color changing luminaires, typically including or more of red, green, blue, and white light-emitting diodes (LEDs), or other combinations of color. With such lighting systems, it is desirable that as much light as possible is emitted from the luminaire. It is also desirable that the light be as well controlled optically as possible. The light beam should be as collimated as possible, and the light shall be well mixed, which no artifacts or evidence of poor color mixing. From an optical design standpoint, this is a challenge, because creating an ideal collimator does not lend itself to be a well-mixed beam of light, free of artifacts or poor color mixing, and vice versa.

### SUMMARY

According to one aspect, the present disclosure is directed to a light-emitting diode (LED) lighting fixture. The fixture includes a substrate and a plurality of LED clusters disposed on the substrate in a plane in which two orthogonal axes defining a two-dimension system is disposed. At least two of the LED clusters have orientations which are relatively angularly displaced within the two-dimensional coordinate system.

In some exemplary embodiments, the substrate is a LED circuit board.

In some exemplary embodiments, the at least two LED clusters are angularly displaced by an angle of 180 degrees.

In some exemplary embodiments, the at least two LED clusters are angularly displaced by an angle of 60 degrees.

In some exemplary embodiments, the at least two LED clusters include multiple LEDs of respective multiple different colors. The LED lighting fixture can further include at least one optical element receiving light from the multiple LEDs and affecting the light to effect color mixing of the light from the multiple LEDs. The at least one optical element can include a collimator. The at least one optical element can include a diffuser.

In some exemplary embodiments, the LED lighting fixture can further include a second plurality of LED clusters disposed on a second substrate being substantially coplanar with the first substrate, the first and second substrates being relatively angularly displaced within the two-dimensional coordinate system, such that the LED clusters are relatively angularly displaced within the two-dimensional coordinate system.

In some exemplary embodiments, the at least two LED clusters are quad LED clusters which include four LEDs of four respective different colors. The four LEDs can include a red LED, a green LED, a blue LED, and a white LED.

### BRIEF DESCRIPTION OF THE DRAWINGS

The present disclosure is further described in the detailed description which follows, in reference to the noted plurality of drawings by way of non-limiting examples of embodiments of the present disclosure, in which like reference numerals represent similar parts throughout the several views of the drawings.

FIG. 1 is a schematic block diagram of an exemplary optical collimator system.

FIGS. 2A and 2B are schematic illustrations of standard color changing LED lighting fixtures, including discrete color LEDs, each with a single optic (collimator).

FIGS. 3A through 3C include schematic illustrations of quad LEDs or clusters of single LEDs, with are used to achieve near-field mixing on the surface of the LED lighting luminaire.

FIG. 4 includes a schematic illustration of a light beam profile of a quad LED system that is optimized around achieving as narrow a light beam as possible, with a well-mixed center, and visible color artifacts in the field of the beam.

FIG. 5 includes an illustration of a conventional light fixture showing the type of optical elements necessary to achieve an even blend of colors at the cost of optical control.

FIG. 6 includes a schematic illustration of a light beam profile of a quad LED system illustrating optical elements such as a diffuser needed to achieve perfect color mixing at the cost of optical control.

FIG. 7A is a top view of a circuit board which includes two quad LED clusters in a conventional orientation.

FIG. 7B is a top detailed view of region 7B of the circuit board indicated in FIG. 7A.

FIG. 7C is a top detailed view of region 7C of the circuit board indicated in FIG. 7A.

FIG. 8A is a top view of a circuit board which includes two quad LED clusters in an orientation with relative angular displacement, i.e., rotation, according to some exemplary embodiments.

FIG. 8B is a top detailed view of region 8B of the circuit board indicated in FIG. 8A.

FIG. 8C is a top detailed view of region 8C of the circuit board indicated in FIG. 8A.

FIG. 9 includes a schematic illustration of a light beam profile of a quad LED system illustrating color mixing achieved with a conventional LED cluster layout, i.e., red (R), green (G), blue (B), and white LEDs having no relative angualar displacent (roatation) beween clusters.

FIG. 10 includes a schematic illustration of a light beam profile of a quad LED system illustrating color mixing achieved with a LED cluster layout, i.e., red (R), green (G), blue (B), and white LEDs having non-zero relative angualar displacent (roatation) beween clusters, specifically, 180 degrees of relative angular displacement (rotation) between adjacent clusters, accrording to some exemplary embodiments.

FIG. 11 includes a schematic illustration of a light beam profile of a quad LED system illustrating color mixing achieved with a LED cluster layout, i.e., red (R), green (G), blue (B), and white LEDs having an optimized non-zero relative angualar displacent (roatation) between clusters, specifically, 60 degrees of relative angular displacement (rotation) between adjacent clusters, accrording to some exemplary embodiments.

FIG. 12 includes a schematic perspective view of a LED lighting system, according to some exemplary embodiments.

FIG. 13A includes a schematic view of a LED circuit board showing quad LED clusters with red (R), green (G), blue (B), and white LEDs having no relative angular displacement (rotation) between clusters.

FIG. 13B includes a schematic detailed view of regions 13B of the LED circuit board indicated in FIG. 13A.

FIG. 14A includes a schematic view of a LED board assembly having multiple individual LED circuit boards thereon, at least two of the LED circuit boards having quad LED clusters with red (R), green (G), blue (B), and white LEDs having non-zero relative angular displacement (rotation) between clusters, at least two of the LED circuit boards also having non-zero relative angular displacement (rotation) between LED circuit boards, for improved light mixing, according to some exemplary embodiments.

FIG. 14B includes a schematic detailed view of region 14B of the LED circuit board indicated in FIG. 14A.

FIG. 14C includes a schematic detailed view of region 14C of the LED circuit board indicated in FIG. 14A.

FIG. 15 includes an LED lighting system having three LED circuit boards disposed at a predetermined angular orientation (rotation) relative to each other in a plane, according to some exemplary embodiments.

FIG. 16 includes a table of measured improvements realized by the LED clusters having relative angular displacement, according to exemplary embodiments.

FIG. 17A includes schematic diagrams illustrating the measurements presented in the table of FIG. 16, with no cluster angular displacement (rotation).

FIG. 17B includes schematic diagrams illustrating the measurements presented in the table of FIG. 16, with cluster angular displacement (rotation), according to some exemplary embodiments.

### DETAILED DESCRIPTION

Conventional LED color changing lighting fixtures typically include a single LED package, for example red (R), green (G), blue (B), and/or white (W) LED elements, combined in a single package with a single optic, e.g., lens, in multiples of three or four (“quad” LED), depending on whether the fixture is an RGB or RGBW unit. In some special cases, five or more individual LEDs can be used in a single package. A reason for this is that having an individual LED combined with a single optic can maximize the Etendue of the system. Etendue is a fundamental property of optical engineering, which is directly related to the LaGrange invariant, in which the relationship between the size of the light source and the size of the aperture (optical collimator) determines the maximum concertation (in this case, beam angle and distribution) of the optical system. This system of having individual LEDs each with individual optics is superior in constructing systems with optimized photometric performances, which is primarily measured in terms of beam narrowness and intensity.

The downside of this system is that when the observer is looking into the system, the individual diode colors are seen, so if the luminaire is set, for example, to light a purple color, the observer will see purple light on the illuminated surface, but individual red (R) and blue (B) “diodes” when looking into the luminaire. To eliminate this drawback, LED manufacturers have introduced integrated “Quad LEDs,” which are single packages with integrated red (R), green (G), blue (B), and white (W) LEDs realized thereon. These quad LEDs are larger in terms of the optical source size, which hurts the overall potential for optical control within the surface due to Etendue, but since all four colors (red, green, blue, and white) are consolidated behind a single collimator, if the luminaire is set to light a purple color, the observer will see purple light on the illuminated surface and also when looking into the fixture.

An additional optical design challenge when designing narrow beams with this system is inherent in the layout of quad chip packages, which can either be four dies on one package or a cluster of individual LEDs placed very closely together. The most straightforward layout electrically on the LED board is to have the same angularly or rotational orientation for each cluster. So, for example, if the LED board has six clusters of LEDs, each cluster would conventionally have the same angular or rotational orientation, so when observed from the front or top of the board, going clockwise from the top left, the ordering of the LED elements would be red, green, blue, and then white. A perfectly optimized collimator, which will focus the source as tightly as possible, will result in a perfect image of the source. However, since the source is a 2×2 cluster of red, green, blue, and white LEDs, the center of the beam will be a mixture of all colors, but the outside field will include each individual color (red, green, blue, and white). The only way to get a uniform color mix in the far field (meaning, on the application surface), is to add diffusion to the system, either with holographic diffusers, volumetric diffusers, or by the addition of textured surfaces or facets on the face of the collimator optic. These features result in a loss of efficiency and intensity in the final distribution, leading to a significant loss in terms of optical efficiency, beam narrowness, and center intensity.

In contrast, in accordance with the current disclosure, if the position of each cluster within a given LED board/luminaire is rotated, i.e., is displaced angularly, the resulting color mixing is greatly improved, and thus the optical performance of the system is preserved. For example, a conventional system with four clusters of LEDs (each being red, then green, then blue, then white in the clockwise direction) in a conventional system is the easiest to lay out electrically. Instead, in a system according to the current disclosure, each quad LED cluster is rotated, i.e., displaced angularly, with respect to at least one other cluster by 90 degrees, each LED color element would occupy each position in the 2×2 grid. According to the exemplary embodiments, in this configuration, the resulting color mixing has been observed in this manner to be improved by up to 87%. The color mixing ability can be measured in terms of Macadam ellipses, which are the accepted SI units for color deviation. According to the exemplary embodiments, the ideal LED layout for these systems is for each LED cluster to occupy each position within a single luminaire. So, if there is a quantity that is not divisible by four, the cluster is rotated by an angle of 360 degrees divided by the quantity of clusters used. For instance, in a system with six LED clusters, the position of each color is rotated by 60 degrees for each instance. Similarly, in a system with twelve LED clusters, the position of each color is rotated by 30 degrees for each instance.

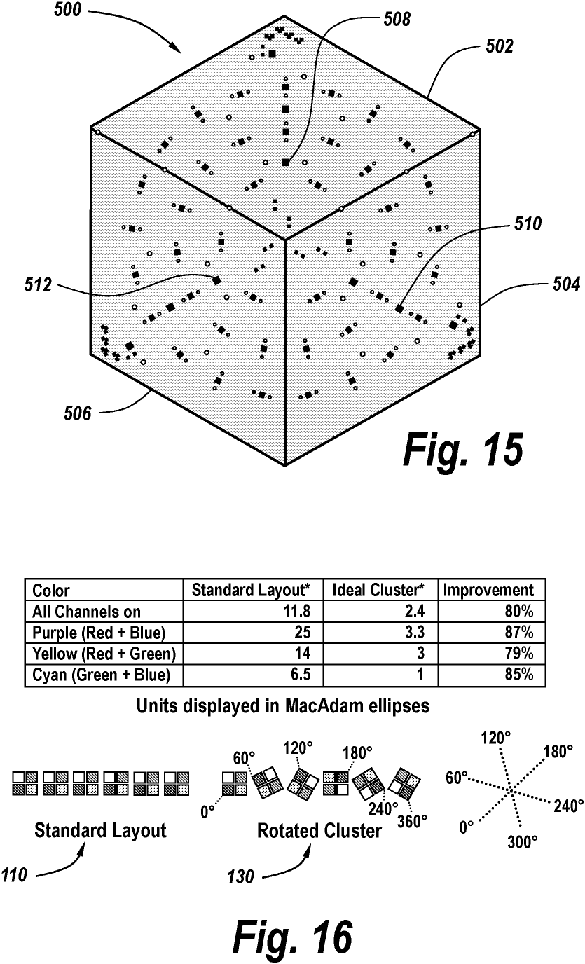

In some exemplary embodiments, it is not possible electrically to achieve this perfect cluster rotation within a single board, so improvements in color mixing can be achieved instead by the rotation of the LED board itself, in the case in which there are multiple LED boards within a single luminaire, such as the system illustrated in FIG. 15. Likewise, the LED positions can be moved around in such a way that each color occupies 50% of the overall cluster footprint instead of 100%, so in a 2×2 grid, one color would only occupy the top left or the bottom right positions. This would result in a lesser improvement in color mixing, but it would be an improvement over the conventional layout where the cluster layout is consistent across the entire LED board/luminaire.

The technology of the present disclosure is not limited only to four-channel systems. For example, some embodiments are directed to two-channel systems, three-channel systems, five-channel systems, or systems having more than five channels. The common goal is to have each separate color occupy the entire area of the source.

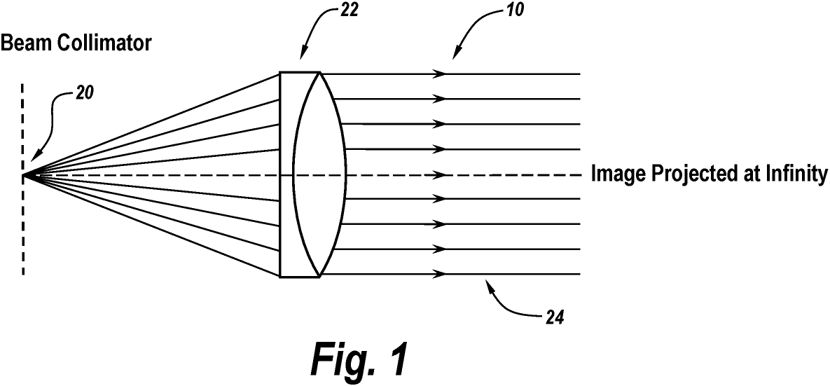

FIG. 1 is a schematic block diagram of an exemplary optical collimator system 10. A beam collimator 10 like those typically used in architectural lighting are designed to achieve as narrow a beam 24 distribution as possible in order to maximize optical control and thus deliver the most light possible on a target. A perfectly optimized collimator will project an image of the source at 20 via one or more optical elements 22 at infinity.

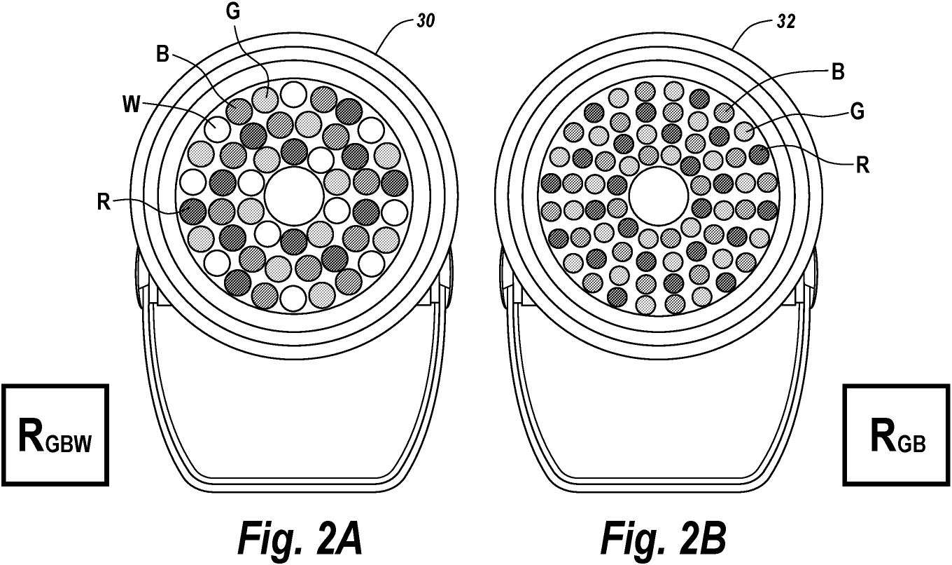

FIGS. 2A and 2B are schematic illustrations of standard color changing LED lighting fixtures, including discrete color LEDs, each with a single optic (collimator). Lighting fixture FIG. 2A illustrates a RGBW fixture 30 using four colored, i.e., red (R), green (G), blue (B), and white (W), individual LEDs. FIG. 2B illustrates a RGB fixture 32 using three colored, i.e., red (R), green (G), and blue (B), individual LEDs.

Referring to FIGS. 2A and 2B, in architectural lighting, historically, color changing fixtures such as illustrated fixtures 30, 32 have been designed with discreet color LEDs, each being paired with its own optic. This approach improves optical performance because it increases the etendue of the system, which is simply defined as the relationship between the size of the optic and the size of the source (LED). Generally, the larger the difference in size between the optic and the source, the greater the optical control.

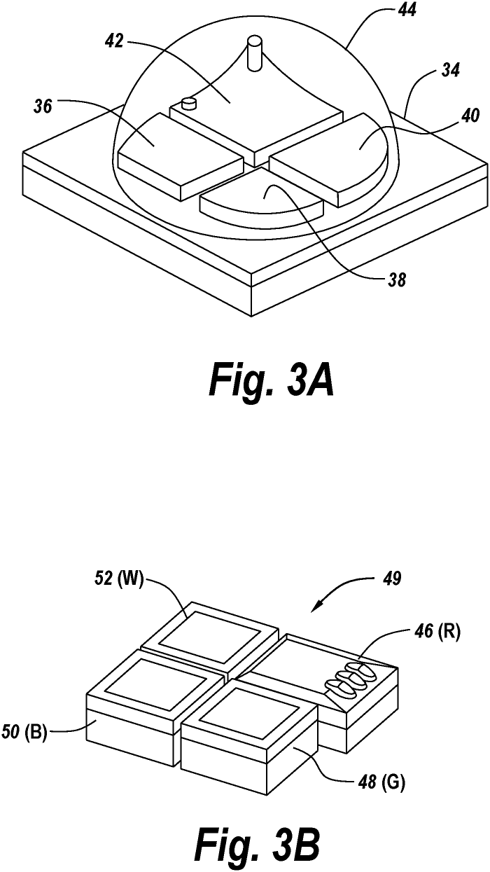

In recent years, LEDs have been created that contain multiple colors in a single package in order to be able to mix in the near field, or within a single optic. These LEDs are naturally larger than individual color LEDs, for example four LEDs in one package/cluster as opposed to just a single LED in each package. So, it is more challenging to create narrow optical distributions. FIGS. 3A through 3C include schematic illustrations of quad LEDs or clusters of single LEDs, with are used to achieve near-field mixing on the surface of the LED lighting luminaire or fixture. Quad LEDs include four channels, typically red (R), green (G), blue (B), and white (W) LEDs on a single package. Specifically, FIG. 3A illustrates a quad LED cluster 34, which includes four LED elements 36, 38, 40, 42 disposed beneath a single optic 44. FIG. 3B illustrates a portion of a RGBW quad LED cluster 49, which includes four LED elements, namely, a red (R) element 46, a green (G) element 48, a blue (B) element (50), and a white (W) element (52). FIG. 3C illustrates a lighting fixture or luminaire 55, which includes multiple clusters of LEDs of the type illustrated in FIGS. 2A and 2B.

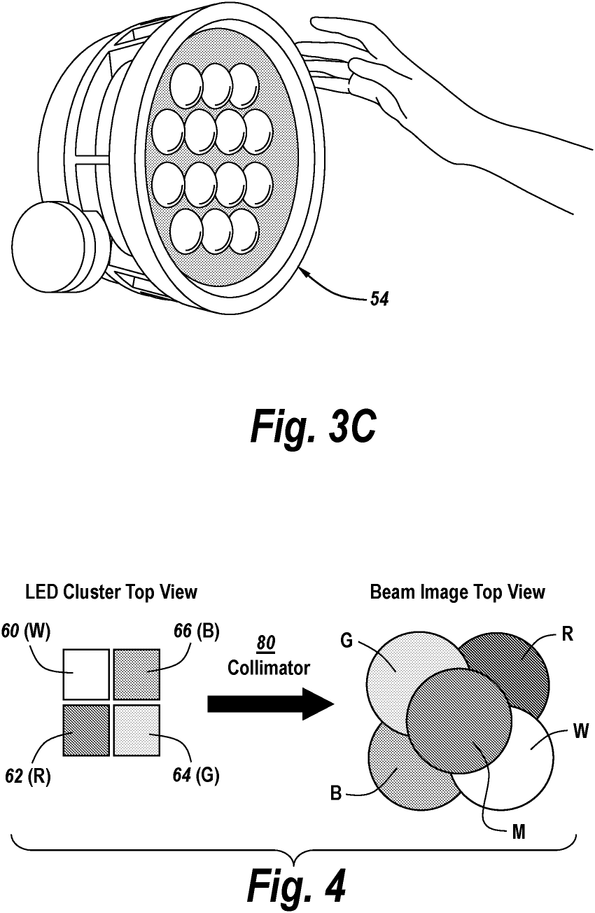

FIG. 4 includes a schematic illustration of a light beam profile of a conventional quad LED system that is optimized around achieving as narrow a light beam as possible. When trying to design as narrow a distribution as possible, the resulting beam image will image the source, which in this case, is a 2×2 LED cluster of Red (R) 62, Green (G) 64, Blue (B) 66, and white (W) 60 LEDs. After a collimator 80, the center of the beam image will be a mixed combination of all four colors, but in the “field” of the image, there will be clear differences in color The resulting beam image includes a well-mixed center region (M), and visible color artifacts in the field of the beam, specifically, R, G, B and W artifacts.

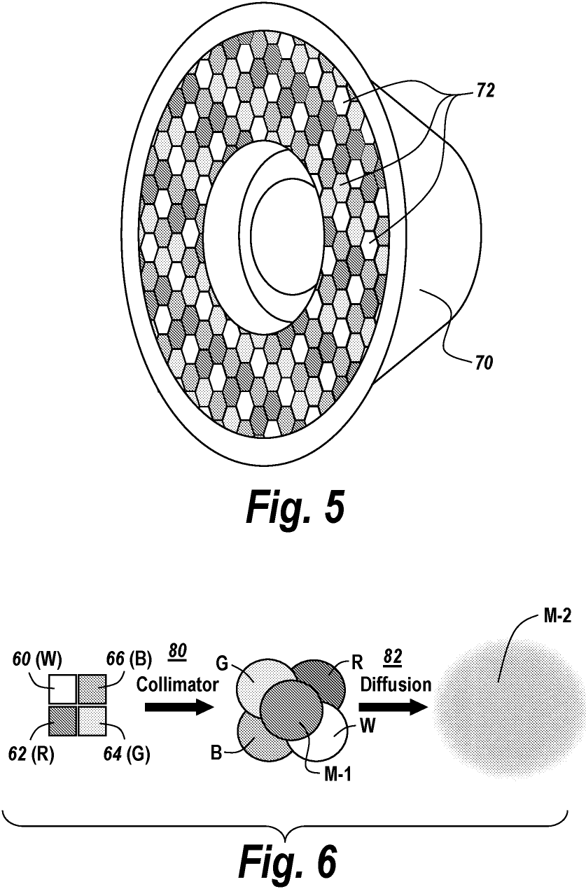

FIG. 5 includes an illustration of a conventional light fixture 70 showing the type of optical elements necessary to achieve an even blend of colors at the cost of optical control. Specifically, the fixture 70 includes multiple Honeycomb lenslets 72 used to improve color mixing.

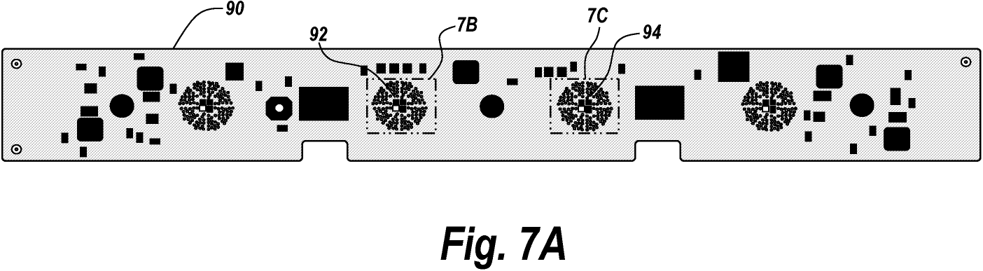

The artifacts in the beam image of FIG. 4 can be corrected by adding diffusion to the system, either by using tertiary optical diffusers or by the addition of other features to the optical system. FIG. 6 includes a schematic illustration of a light beam profile of a quad LED system illustrating optical elements needed to achieve perfect color mixing at the cost of optical control. The system of FIG. 6 differs from the system of FIG. 4 in that the system of FIG. 6 includes diffusion, i.e., diffuser, 82. The beam image M-1 formed in the system of FIG. 4 is applied to diffusion 82, which results in creating an improved mixed output M-2. This improves the color mixing of the system, but at a significant cost to the optical performance, measured in beam angle and luminous intensity.

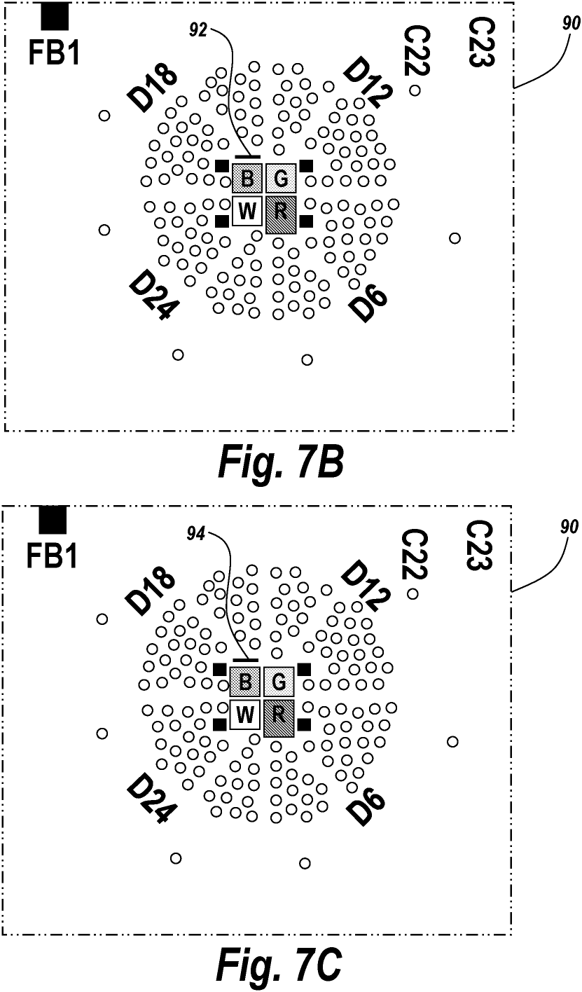

FIG. 7A is a top view of a LED circuit board 90 which includes two quad LED clusters 92 and 94 in a conventional orientation. FIG. 7B is a top detailed view of region 7B of the LED circuit board 90 indicated in FIG. 7A. FIG. 7C is a top detailed view of region 7C of the LED circuit board 90 indicated in FIG. 7A. Each of clusters 92 and 94 includes four LEDs, red (R), green (G), blue (B), and white (W). As shown from cluster 92 to cluster 94, each of the individual LEDs occupies the same position in the pair of 2×2 arrays. That is, in both clusters, red (R) is in the bottom right position, green (G) is in the top right position, blue (B) is in the top left position, and white (W) is in the bottom left position. That is, there is no angular displacement or “rotation” of the clusters with respect to each other in the plane of the top surface of the LED circuit board 90.

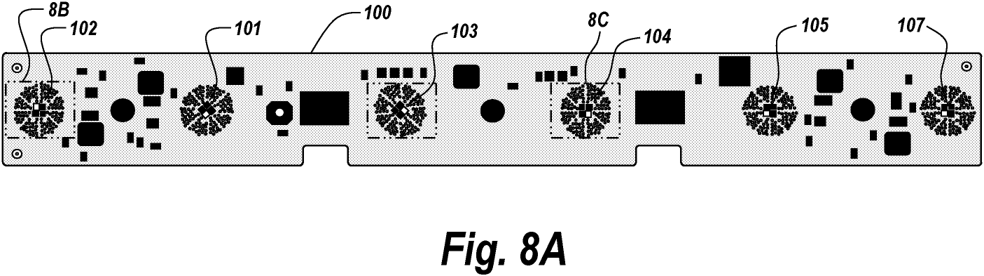

FIG. 8A is a top view of a LED circuit board 100 which includes two quad LED clusters 102 and 104 in an orientation with relative angular displacement, i.e., rotation, according to some exemplary embodiments. In the particular illustrated embodiment, six LED clusters 102, 101, 103, 104, 105, and 107 with various relative angular displacements, i.e., rotations, are shown. Exemplary clusters 102 and 104 have 180 degrees relative angular displacements (rotation). Other angular displacements (rotations) are within the scope of this disclosure. FIG. 8B is a top detailed view of region 8B of the LED circuit board 100 indicated in FIG. 8A. FIG. 8C is a top detailed view of region 8C of the LED circuit board 100 indicated in FIG. 8A. Each of clusters 102 and 104 includes four LEDs, red (R), green (G), blue (B), and white (W). From cluster 102 to cluster 104, each of the individual LEDs occupies a different position in the pair of 2×2 arrays. That is, in cluster 102, red (R) is in the bottom left position, green (G) is in the top right position, blue (B) is in the bottom right position, and white (W) is in the top left position. Because of the angular displacement of the current technology, in cluster 104, red (R) is in the top right position, green (G) is in the bottom left position, blue (B) is in the top left position, and white (W) is in the bottom right position. That is, according to the current technology, there is non-zero relative angular displacement or “rotation” of the clusters 102 and 104 with respect to each other in the plane of the top surface of the LED circuit board 100.

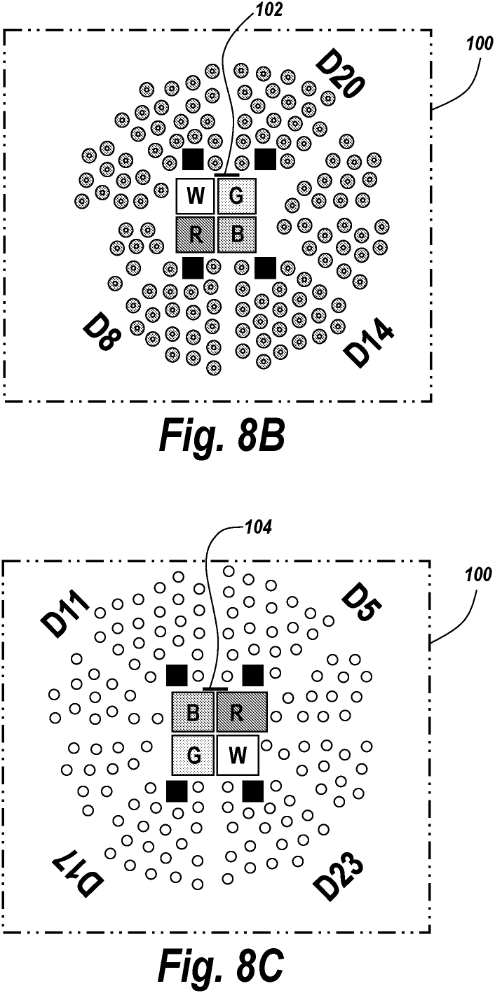

FIG. 9 includes a schematic illustration of a light beam profile of a quad LED system illustrating color mixing achieved with a conventional LED cluster layout 110, i.e., red (R), green (G), blue (B), and white LEDs, having no relative angualar displacent (rotation) beween clusters. This standard layout on electronic LED boards has the same orientation for each LED cluster, which is the easiest and most straightforward layout when doing the electrical traces from LED to LED. The light beam profile includes a central color mixed region M and individual non-mixed regions R, G, B, W at its edges.

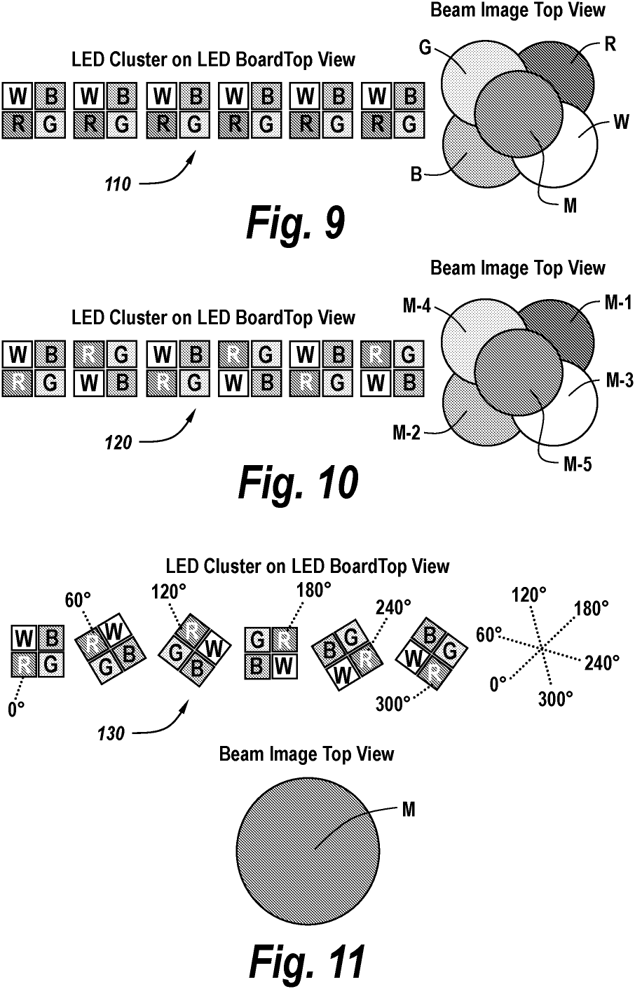

FIG. 10 includes a schematic illustration of a light beam profile of a quad LED system illustrating color mixing achieved with a LED cluster layout 120, i.e., red (R), green (G), blue (B), and white LEDs having non-zero relative angualar displacent (roatation) beween clusters, specifically, 180 degrees of relative angular displacement (rotation) between adjacent clusters, accrording to some exemplary embodiments. This illustration shows relative improvement over the system of FIG. 9, but is not fully optimized. With the LED clusters 120 rotated 180 degrees as shown, the field images have improved mixing, but not ideal. As shown, opposite corners mix, red with blue to form mixed regions M-1 and M-2, and green with white to form mixed regions M-3 and M-4. These are outside the edges of central mixed region M-5

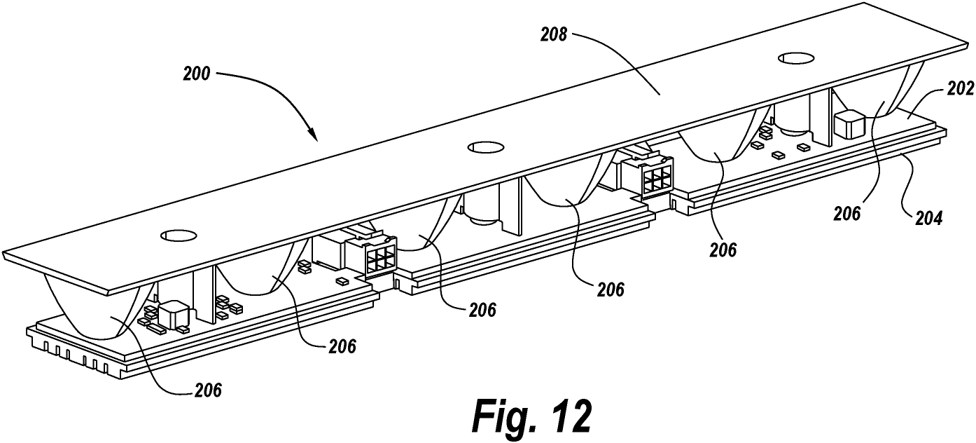

FIG. 11 includes a schematic illustration of a light beam profile of a quad LED system illustrating color mixing achieved with a LED cluster layout 130, i.e., red (R), green (G), blue (B), and white LEDs having an optimized non-zero relative angualar displacent (rotation) between clusters, specifically, 60 degrees of relative angular displacement (rotation) between adjacent clusters, accrording to some exemplary embodiments.If the clusters are rotated such that each color is evenly distributed throughout an entire board/luminaire, it allows for the field to be evenly mixed as shown in mixed region M, allowing for maximized optical performance (narrower distribution, higher intensity). This is because within the field, each color (red, green, blue, and white) is distributed evenly within the entire optical system including multiple LED clusters/LED boards within a single luminaire.

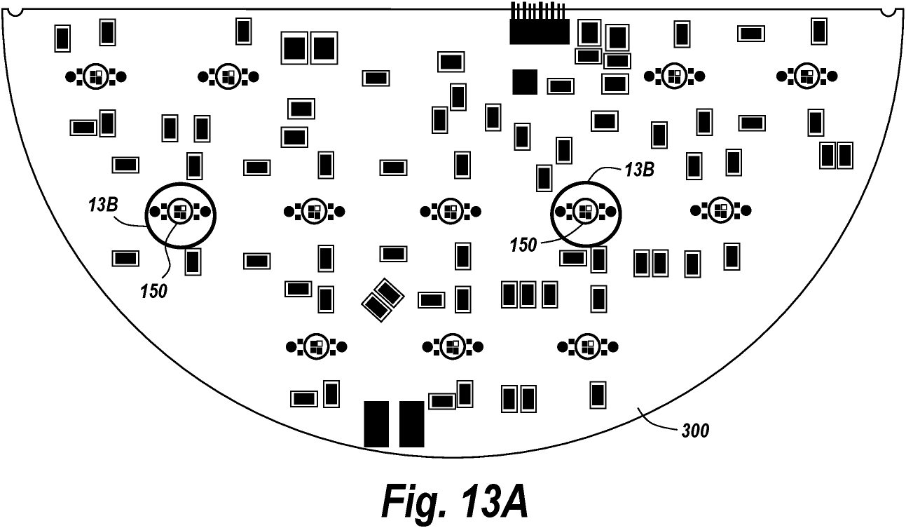

FIG. 12 includes a schematic perspective view of a LED lighting system 200, according to some exemplary embodiments. Lighting system 200 includes one or more LED circuit boards 202, on which are formed, for example, six, LED clusters (not shown) having relative angular displacement (rotation), as described above in detail. System 200 can also include optic elements 206, such as collimators, each located over one of the six LED clusters. A top plate 208 is located over LED board 202, the LED clusters (not shown), and the collimators 206. The top plate can be optically transparent, or it can be frosted to provide diffusion for better color mixing as described above in detail. LED circuit board 202 can be in contact with a heatsink 204.

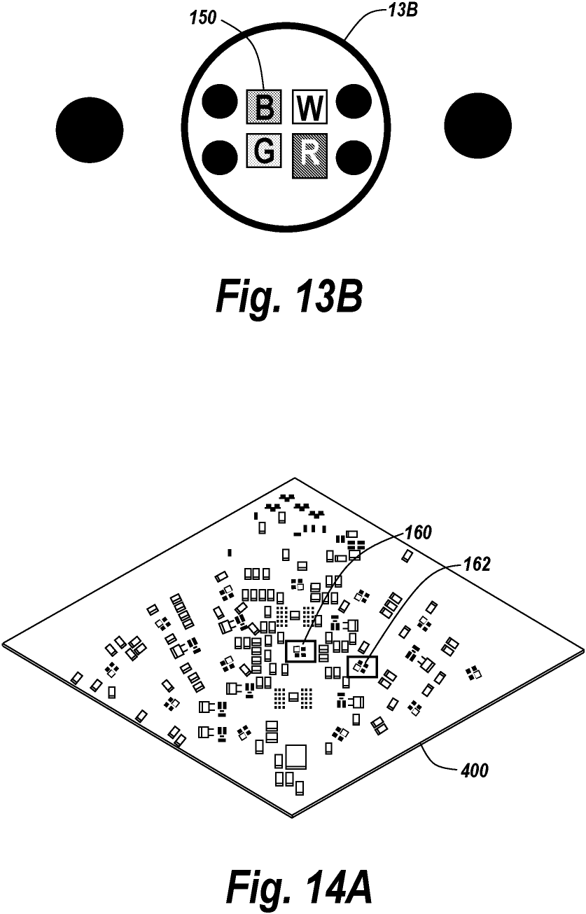

FIG. 13A includes a schematic top view of a LED circuit board 300 showing quad LED clusters 150 with red (R), green (G), blue (B), and white LEDs having no relative angular displacement (rotation) between clusters. FIG. 13B includes a schematic detailed view of regions 13B of the LED circuit board 300 indicated in FIG. 13A.

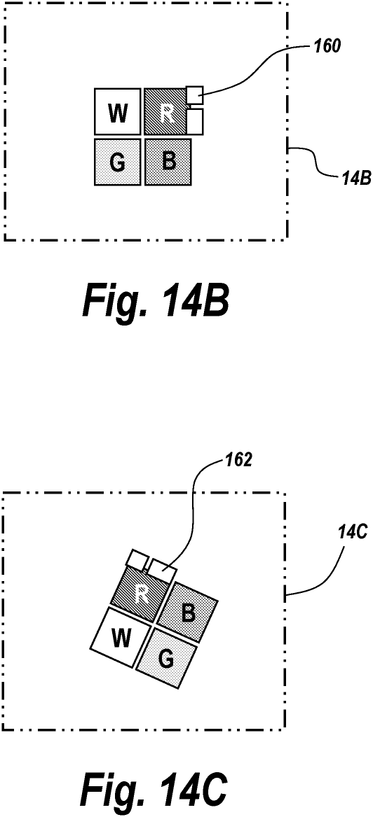

FIG. 14A includes a schematic view of a LED circuit board 400 having multiple individual LED clusters 160 and 162 mounted thereon, at least two of the LED clusters 160, 162 having red (R), green (G), blue (B), and white LEDs having non-zero relative angular displacement (rotation) between clusters, according to exemplary embodiments. FIG. 14B includes a schematic detailed view of region 14B of the LED circuit board 400 indicated in FIG. 14A. FIG. 14C includes a schematic detailed view of region 14C of the LED circuit board indicated in FIG. 14A.

FIG. 15 includes an LED lighting system 500 having three LED circuit boards 502, 504, 506 disposed at a predetermined angular orientation (rotation) relative to each other in a plane. Each LED circuit board 502, 504, 506 includes at least one LED cluster 508, 510, 512, respectively. Each LED ciruit board 502, 504, 506 is oriented to provide a desired relative angular displacement (rotation) of any LED clusters mounted on the board. In addition, each LED cluster 508, 510, 512 can be oriented to provide a desired relative angular displacement (rotation). That is, the orientation of both the LED circuit boards and the LED clusters on the boards can be selected based on a desired relative angular displacement (rotation).

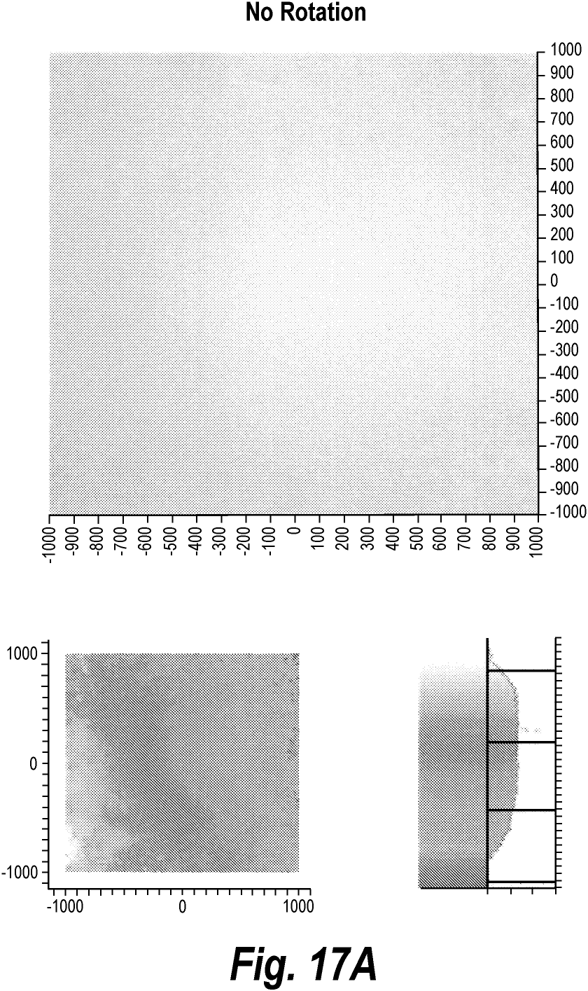

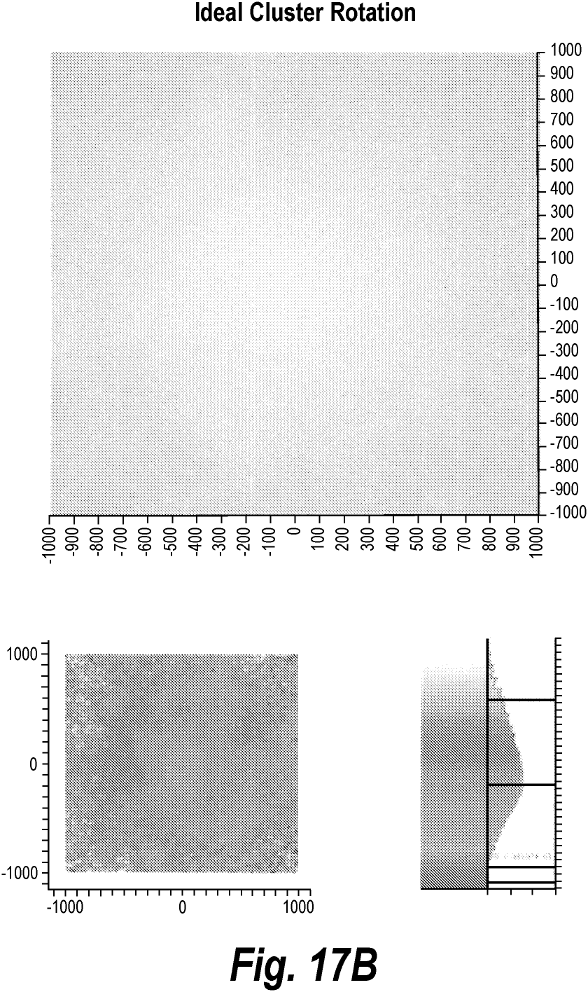

FIG. 16 includes a table of measured improvements realized by the LED clusters having relative angular displacement (rotation), according to exemplary embodiments. FIG. 17A includes schematic diagrams illustrating the measurements presented in the table of FIG. 16, with no cluster angular displacement (rotation), i.e., the cluster configuration 110 of FIG. 9. FIG. 17B includes schematic diagrams illustrating the measurements presented in the table of FIG. 16, with cluster angular displacement (rotation), i.e., the cluster configuration 130 of FIG. 11, according to the present disclosure. The units used here are deviations in color chromaticity from the average color point. As shown in FIGS. 16, 17A, and 17B, with no cluster rotation, zones of color are observed on the bottom left and top right of the beam image. In contrast, with cluster rotation, it is observed that the color deviations are more evenly distributed within the beam image, leading to much improved color mixing across all possible colors.

Whereas many alterations and modifications of the disclosure will become apparent to a person of ordinary skill in the art after having read the foregoing description, it is to be understood that the particular embodiments shown and described by way of illustration are in no way intended to be considered limiting. Further, the subject matter has been described with reference to particular embodiments, but variations within the spirit and scope of the disclosure will occur to those skilled in the art. It is noted that the foregoing examples have been provided merely for the purpose of explanation and are in no way to be construed as limiting of the present disclosure.

While the present inventive concept has been particularly shown and described with reference to exemplary embodiments thereof, it will be understood by those of ordinary skill in the art that various changes in form and details may be made therein without departing from the spirit and scope of the present inventive concept as defined by the following claims.

1. A light-emitting diode (LED) lighting fixture, comprising:
a substrate;
a plurality of LED clusters disposed on the substrate in a plane in which two orthogonal axes defining a two-dimension system is disposed, at least two of the LED clusters having orientations which are relatively angularly displaced within the two-dimensional coordinate system.

2. The LED lighting fixture of claim 1, wherein the substrate is a LED circuit board.

3. The LED lighting fixture of claim 1, wherein the at least two LED clusters are angularly displaced by an angle of 180 degrees.

4. The LED lighting fixture of claim 1, wherein the at least two LED clusters are angularly displaced by an angle of 60 degrees.

5. The LED lighting fixture of claim 1, wherein the at least two LED clusters include multiple LEDs of respective multiple different colors.

6. The LED lighting fixture of claim 5, further comprising at least one optical element receiving light from the multiple LEDs and affecting the light to effect color mixing of the light from the multiple LEDs.

7. The LED lighting fixture of claim 6, wherein the at least one optical element comprises a collimator.

8. The LED lighting fixture of claim 6, wherein the at least one optical element comprises a diffuser.

9. The LED lighting fixture of claim 1, further comprising a second plurality of LED clusters disposed on a second substrate being substantially coplanar with the first substrate, the first and second substrates being relatively angularly displaced within the two-dimensional coordinate system, such that the LED clusters are relatively angularly displaced within the two-dimensional coordinate system.

10. The LED lighting fixture of claim 1, wherein the at least two LED clusters are quad LED clusters which include four LEDs of four respective different colors.

11. The LED lighting fixture of claim 10, wherein the four LEDs include a red LED, a green LED, a blue LED, and a white LED.
